(19) United States
(12) Patent Application Publication
(10) Pub. No.: US 2010/0135419 A1
(43) Pub. Date: Jun. 3, 2010

(54) METHOD, APPARATUS AND SYSTEM FOR PROVIDING DISPLAY DEVICE SPECIFIC CONTENT OVER A NETWORK ARCHITECTURE

(75) Inventors: Ingo Tobias Doser, Donaueschingen (DE); Xueming Henry Gu, Calabasas, CA (US); Bongsun Lee, La Crescenta, CA (US)

Correspondence Address: Robert D. Shedd, Patent Operations;THOMSON Licensing LLC, P.O. Box 5312, Princeton, NJ, 08543-5312, US

(73) Assignee: THOMSON LICENSING

(21) Appl. No.: 12/452,130

(22) PCT Filed: Jun. 28, 2007
(86) PCT No.: PCT/US2007/015245

§ 371 Date: Dec. 16, 2009

(51) Int. Cl. H04N 7/12; H04N 5/66; H04N 7/173

(52) U.S. Cl. 375/240.26; 348/739; 725/117; 375/E07.076; 348/E05.133

(57) ABSTRACT

Embodiments of a method, apparatus and system for providing display device specific picture content over a network architecture include at least one content server for storing a plurality of virtual model versions of the content respectively generated in accordance with a plurality of virtual device models. Each of the plurality of virtual device models has a virtual model specification (VMS) which controls at least one display feature. In one embodiment, the at least one content server engages in negotiations with at least one network attached unit to permit a selection of a particular one of the plurality of virtual model versions based on a comparison of at least one of the at least one display feature of the virtual model specification of at least one of the plurality of virtual device models against an actual display requirement included in an actual display specification of a particular display.

### TECHNICAL FIELD

The present invention generally relates to content display, and more particularly, to methods and systems for providing display device specific content over a network architecture.

### BACKGROUND OF THE INVENTION

With the advent of new content distribution technologies such as, for example, Very high rate Digital Subscriber Line (VDSL), or technologies that offer point to point connections with respect to a home and a content server, new application opportunities arise.

In consumer viewing, one of the issues that have been identified is that today's consumer displays and viewing situations cause alterations in picture representations so that the original color composition, the creator's intent, is not properly represented as the creator intended. It is to be noted that in cases of point to multipoint communication scenarios, as well as in cases of packaged media, it is a current practice to presume a standardized viewing device and a standardized viewing environment. In fact, this is the only feasible possibility with today's technology. However, it has therefore been found that one master picture cannot serve the variety of display configurations and viewing conditions currently encountered at the consumer side.

For example, currently imagery for home video viewing is color corrected mainly on studio monitors which are known to be highly accurate cathode ray tube

(CRT) monitors. However, although those are typically high quality display devices, in reality, cathode ray tube displays have less and less in common with the display devices that are actually and currently used in homes. The newer display devices used in homes differ in at least display brightness, color gamut, contrast ratio, spatial, and temporal behavior. The situation is further complicated given the fact that individual display technologies are diverging among themselves by new advances in backlight technology, power management, and so forth.

In addition, there is a completely new type of home viewing environment emerging with screens of one hundred inches or more in size. These new displays have completely new requirements with respect to the color grading process in a home video framework. In fact, the requirements of these particular viewing environments may be closer to digital cinema requirements than they are to home video requirements.

### SUMMARY OF THE INVENTION

Embodiments of the present principles provide methods and systems for providing display device specific content over a network architecture.

In one embodiment of the present invention, a method for providing display device specific video content over a network includes determining a plurality of virtual model versions of the video content generated in accordance with a plurality of respective virtual device models, each of the plurality of virtual device models having a virtual model specification which represents at least one display feature of a particular reference display, and selecting a particular one of the plurality of virtual model versions for display based on a comparison of at least one of the display features of the virtual model specification and a display feature of an intended display for display. The method of the present invention can further include engaging in negotiations to permit a remote selection of a particular one of the plurality of virtual model versions based on a comparison of at least one of the at least one display feature of the virtual model specification of at least one of the plurality of virtual device models against an actual display feature included in a display specification of the intended display.

In an alternate embodiment of the present invention, a system for providing display device specific video content over a network includes at least one content server for storing a plurality of virtual model versions of the video content generated in accordance with a plurality of respective virtual device models, each of the plurality of virtual device models having a virtual model specification which represents at least one display feature of a particular reference display and at least one network attached unit for enabling a selection of a particular one of the plurality of virtual model versions for display based on a comparison of at least one of the display features of the virtual model specification and a display feature of an intended display.

In one embodiment of a system of the present invention, the at least one content server is configured to engage in negotiations to permit a remote selection of a particular one of the plurality of virtual device versions based on a comparison of at least one of the at least one display feature of the virtual model specification of at least one of the plurality of virtual device models against an actual display feature included in a display specification of the intended display. In the above described embodiment, an intended network attached unit can be configured to engage in negotiations with the at least one content server to perform a selection of a particular one of a plurality of virtual model versions of the content.

In an alternate embodiment of the present invention, an apparatus for providing display device specific video content over a network includes a decision matrix for selecting a particular one of a plurality of stored virtual model versions of the video content and communicating a request for the selected virtual model version, and a signal transformer for applying a transform to received video content for transforming received video content to the selected virtual model version for display. In various embodiments of the present invention, the apparatus can further include a database for storing at least one of virtual model versions, virtual device models and display features.

These and other aspects, features and advantages of the embodiments of the present invention will become apparent from the following detailed description of exemplary embodiments, which is to be read in connection with the accompanying drawings.

### BRIEF DESCRIPTION OF THE DRAWINGS

The teachings of the present invention can be readily understood by considering the following detailed description in conjunction with the accompanying drawings, in which:

FIG. 1 depicts a high level block diagram of an exemplary system for providing display device specific content over a network architecture, in accordance with an embodiment of the present invention;

FIG. 2 depicts a high level block diagram of a portion of a user side, relating to a single user, suitable for use in the system of FIG. 1, in accordance with an embodiment of the present invention;

FIG. 3 illustratively depicts signal flow from the server side to the user side in accordance with an embodiment of the present invention;

FIG. 4 depicts a data exchange between the server side and a user side in accordance with an embodiment of the present invention;

FIG. 5 depicts a data exchange between the server side and a user side in accordance with an alternate embodiment of the present invention;

FIG. 6 depicts a data exchange between the server side and a user side in accordance with yet an alternate embodiment of the present invention;

FIG. 7 depicts a data exchange between the server side and a user side in accordance with yet an embodiment of the present invention; and

FIG. 8 depicts a high level block diagram of a portion of the user side, relating to a single user, suitable for use in the system of FIG. 1 in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

Embodiments of the present invention advantageously provide methods and systems for providing display device specific content over a network architecture. Although the present embodiments will be illustratively described primarily within the context of providing picture content using the International Organization for Standardization/ International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 recommendation (hereinafter the “MPEG-4 AVC standard”), the specific embodiments of the present invention should not be treated as limiting the scope of the invention. It will be appreciated by those skilled in the art and informed by the teachings of the present invention that the concepts of the present invention can be advantageously utilized with other video coding standards, recommendations, and extensions thereof, including extensions of the MPEG-4 AVC standard.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

As used herein, the acronym “VC denotes video content. In one embodiment of the present invention, there is one VC per movie feature or other picture product, which can include several virtual device model versions.

The acronym “VM” denotes virtual device model. The virtual device model represents the specification of a display or a group of displays. Regarding the phrase “VM Version”, there is one version of the content for each VM.

The acronym “VMS” denotes virtual device model specification. This is the specification of one particular VM, and includes specification details including, but not limited to, contrast ratio, signal accuracy, and other display parameters.

The acronym “ADS” denotes an actual device model specification. The ADS is the specification of one particular display. This ADS is used for choosing the VM version by matching the ADS and the VMS.

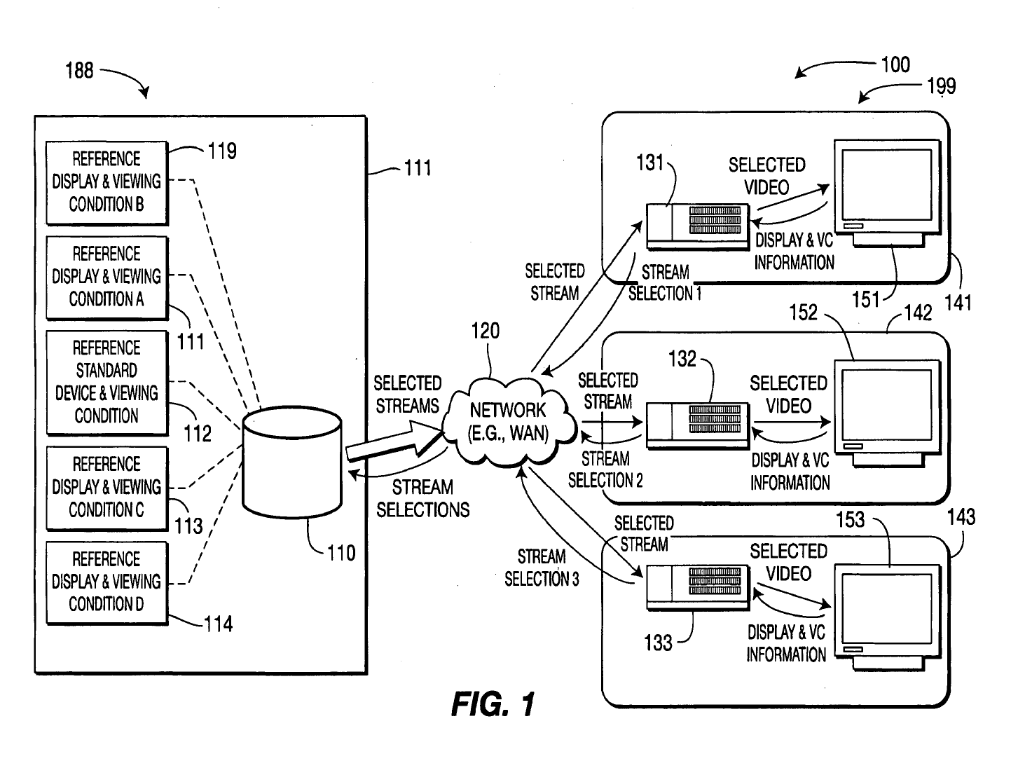

FIG. 1 depicts a high level block diagram of an exemplary system for providing display device specific content over a network architecture, in accordance with an embodiment of the present invention. The system 100 of FIG. 1 illustratively includes a content server 111 having a network database(s) 110 connected to a network 120 which, in turn, is connected to various network attached units (NAUs) 131, 132, 133. The NAUs 131, 132, and 133 are associated with various users 141, 142, and 143, respectively. In the system 100 of FIG. 1, the NAUs 131, 132, and 133 are connected to displays 151, 152, and 153, respectively.

In the example of FIG. 1, the network database 110 can be implemented with a content server and, thus, the phrases “network database” and “content server” and “server” are used interchangeably herein. Moreover, in the embodiment of FIG. 1, the network database 110 is attached to the network 120 to provide point to point connections with users attached to this network 120. Of course, the present principles are not limited solely to the use of point to point connections and, thus, other types of connections and communication technologies can also be used in accordance with the principles of the present invention, while maintaining the spirit of the present invention.

In the embodiment of the system 100 of FIG. 1, the network database 110 stores specifications for a reference standard device and viewing condition 119. The network database 110 also stores specifications for a reference display and viewing condition A, a reference display and viewing condition B, a reference display and viewing condition C, and a reference display and viewing condition D, also denoted by the reference numerals 111, 112, 113, and 114, respectively.

Each user 141, 142, and 143, via the NAUs 131, 132, and 133, respectively, is capable of making a stream selection, respectively denoted as stream selection 1, stream selection 2, and stream selection 3, which is provided to the network database 110 via the network 120. The network database 110 then provides the selected stream(s) to the appropriate user via the network 120. The selected streams are ultimately provided as selected video to the appropriate display device.

Additionally, display and video content (VC) information is provided from the displays 151, 152, and 153 to the respective NAUs 131, 132, and 133 for use during negotiations between the displays 151, 152, and 153 and the respective NAUs 131, 132, and 133. The user associated equipment, namely the NAU 131 and display 151 for user 141, the NAU 132 and display 152 for user 142, and the NAU 133 and display 153 for user 143 correspond to a user side 199. The network database 110 corresponds to a server side 188. As such, in the exemplary system 100 of FIG. 1, five different VM versions are stored on the network database. These versions are a “standard version” 119, and VM versions A, B, C and D, also denoted by the reference numerals 111, 112, 113, and 114, respectively.

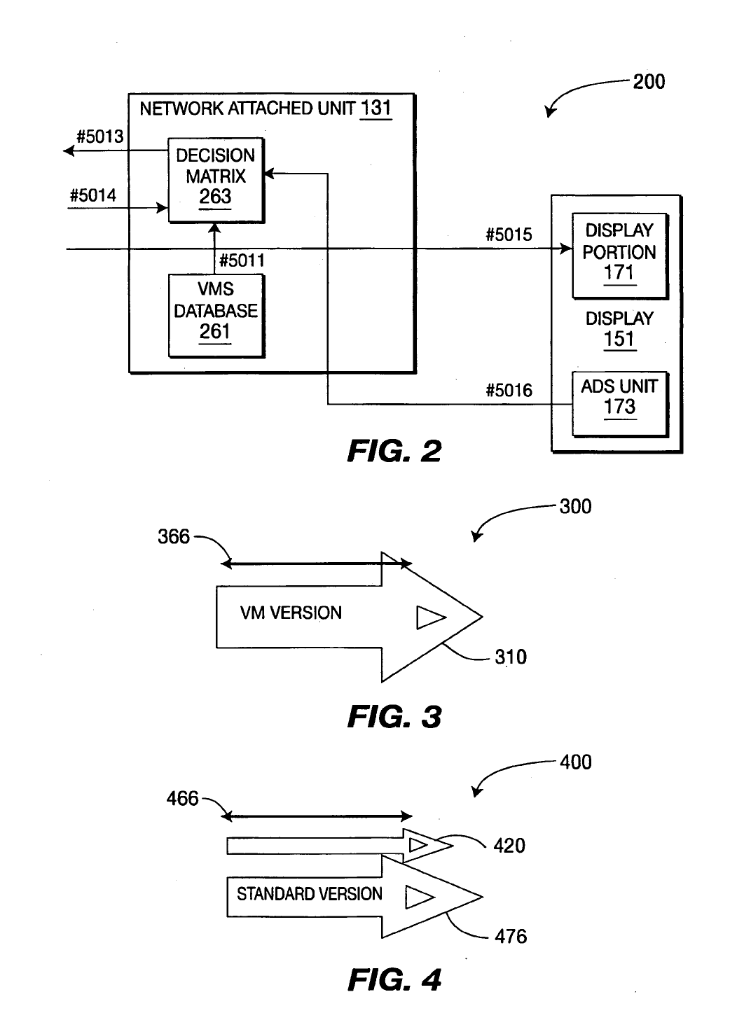

As further described below, the respective display of a user transfers its ADS to a corresponding NAU. Thus, for example, with respect to user 141, display 151 transfers its ADS to NAU 131 which then compares this data with the reference data for the available content (ADS-VMS matching as further described below), and so on with respect to each of the users. An embodiment showing the ADS-VMS matching of an embodiment of the present invention is illustrated with respect to FIG. 2. It is to be appreciated that while only one network database 110 is shown in FIG. 1, the present principles are not limited to embodiments having only one database and, thus, more than one database can be utilized. For example, in one exemplary embodiment, there can be one database for each virtual model version of the video content.

FIG. 2 depicts a high level block diagram of a portion 200 of a user side 199, relating to a single user 141, suitable for use in the system 100 of FIG. 1, in accordance with an embodiment of the present invention. The portion 200 of the user side 199 includes the NAU 131 and the display 151. For illustrative purposes, the description of FIG. 2, as well as other FIGURES herein, is made with respect to user 141 and correspondingly NAU 131 and display 151. However, it is to be appreciated that the inventive concepts described with respect to FIG. 2 are equally applicable to the other users and other corresponding NAUs and displays.

Referring to FIG. 2, the display 151 includes a display portion 171 and an ADS unit 173. The NAU 131 includes a VMS database 261 and a decision matrix 263. The VMS database 261 has an output connected to a first input of a decision matrix 263. The decision matrix 263 further includes a second input and an output, both respectively available as an input and an output of the NAU 131, for respectively receiving and transmitting data to the server side 188. An output of the ADS unit 173, which is available as an output of the display 151, is connected to a third input of the decision matrix 263.

The second input of the decision matrix 263 may, for example signal a request 5013 to the content server 111, which can be located at a remote location, to download or stream one particular feature film that exists in several VM versions. The content server 111 provides a response 5014 to the request. The response 5014 signals what VM versions of that feature film are available for streaming/downloading.

Subsequently, the decision matrix 263 of the NAU 131 receives an ADS 5016 from the ADS unit 173 of the display 151. The Decision Matrix 263, on the other hand, accesses a VMS database that could be stored either locally or remotely picks the VMS according to the available VM versions. The Decision Matrix 263 then selects the VM that is the best fit for the particular display 151 by comparing, in one embodiment, a best match of the ADS with the VMS of the available VM versions. This decision 5013 is communicated to the content server 111 which then provides the VM version 5015 for streaming to the NAU 131. The NAU 131 then communicates the video signal to the display 151, in particular, the display portion 171. It is to be appreciated that in one or more embodiments, the content may have to be reformatted or decompressed prior to display on the display portion 171.

Advantageously, the above described embodiment of the present invention overcomes the typically encountered prior art deficiency of presuming a standardized viewing device and a standardized viewing environment by providing display device specific content for each group of displays and viewing environments or for each individual display and viewing environment. The different types of display content are made available for delivery to respective consumers for their respective display technology and viewing situation. Such individual displays and/or groups of displays can include, but are not limited to, for example, the following types of displays and display technologies: liquid crystal display (LCD); Plasma, cathode ray tube (CRT); digital light processing (DLP); and silicon crystal reflective display (SXRD).

In one embodiment, the system of the present invention use a point to point connection to provide consumers with a version of the picture material adapted to their display and viewing conditions. Of course, the present principles are not limited solely to the use of point to point connections and, thus, other types of connections and communication technologies can also be employed in accordance with the concepts of the present invention.

When delivering content, a decision is made which essentially selects only one version of the content. When broadcasting, only one version can be broadcasted per channel at one particular time. Using packaged media like digital video disks (DVDs), high-definition digital video disks (HD-DVDs), and Blue ray disks (BDs), in order to avoid confusion with multiple inventories, again only one version can be chosen for delivery. However, in accordance with alternate embodiments of the present invention, exceptions are made with respect to the preceding conventional approach.

Embodiments of the present invention are directed at least in part to addressing the storage of media content on a network server side, the selection of content according to negotiations with a network attached unit (NAU) side, the delivery of the media content to the NAU side (e.g., the retrieval of the content on the NAU side), and the negotiation process between the NAU and the attached display and/or the user. In one or more embodiments of the present invention, different VM versions based on the actual display and viewing environment are generated in addition to the “standard version(s)”. For example, in one embodiment of the present invention (hereinafter referred to as “content scenario 1”), each VM version is stored at a different location. In an alternate embodiment of the present invention (hereinafter referred to as “content scenario 2”), the different VM versions are encoded in a hierarchical manner. In yet an alternate embodiment of the present invention (hereinafter referred to as “content scenario 3”), the different VM versions have one “mother” content and metadata describing the transform for each VM.

In accordance with various embodiments of the present invention, on the content server side, the following exemplary implementation approaches can be used for the above described scenarios. For example, in the case of content scenario 1, the content server negotiates with the NAU about the selection of the VM version. There are several exemplary negotiation terms that can be used. One exemplary negotiation term is the ADS of the user display. In a selection process involving the ADS, content is selected for use by matching the ADS with all available VMSs, in order to find the best match. Another exemplary negotiation term is the eligibility of the NAU to receive a version of the content that is superior to the “standard version”. In one embodiment, this decision can be related to product pricing. The server then selects the corresponding version of the content for delivery to the NAU.

In the case of content scenario 2, the same general concept as applied for the above described content scenario 1 is used, but with the difference of having one database per VC. This is based on the concept of having one base video content, (the “standard version”) and one or several “enhancement layers”, each describing the difference between different VM Versions. In one embodiment of the present invention, these “enhancement layers” can be implemented in the uncompressed domain, where a simple difference picture between the standard version and the enhanced version is stored. However, it is advantageous to use more advanced possibilities such as a scalable encoding. In such an embodiment, a base layer compliant with the MPEG-4 AVC standard, in combination with one or several MPEG-4 AVC standard (scalable video encoders and/or decoders) compressed enhancement layers, are stored. One VM version can then be derived from the base layer plus at least one enhancement layer.

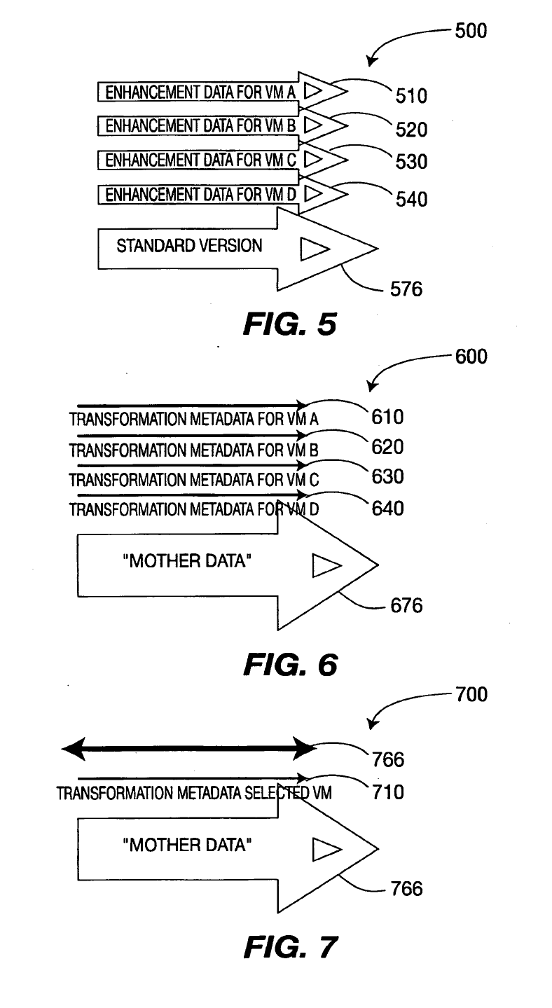

The following examples include embodiments of possible server implementation scenarios in the case of content scenario 2. One exemplary server implementation scenario (hereinafter referred to as “scenario 2, application 1”) involves delivering the whole database to the customer and letting the respective NAU extract the data that is relevant, determined by the ADS of the user display (see FIG. 3). In another exemplary server implementation scenario (hereinafter referred to as “scenario 2, application 2”), the data that is relevant, determined by the ADS of the user display, which is communicated by the NAU, is extracted and delivered to an NAU as-is (see FIG. 4). In yet another exemplary server implementation scenario (hereinafter referred to as “scenario 2, application 3”), the data that is relevant, determined by the ADS of the user display and communicated by the NAU is extracted. The extracted data is then transcoded to a different format, for example, but not limited to, a single layer AVC format, and delivered to an NAU (see FIG. 5).

For example, FIG. 3 illustratively depicts a signal flow 300 from the server side 188 to a NAU(s) on the user side 199 for scenario 2, application 1, in accordance with an embodiment of the present invention. In the embodiment of FIG. 3, all VM versions 310 are signaled from the server side 188 to the appropriate NAU(s) on the user side 199, to allow the corresponding NAU to extract the relevant data, as determined by the ADS of the corresponding display. The bi-directional communications, as described herein, between the server side 188 and the user side 199 are indicated by the bi-directional arrow 366.

FIG. 4 depicts the data exchange 400 between the server side 188 and a NAU(s) on the user side 199 for scenario 2, application 2, in accordance with an embodiment of the present invention. In the embodiment of FIG. 4, enhancement data 420 for VM is communicated from the server side 188 to the appropriate NAU(s) on the user side 199. In addition, the standard version 476 is communicated from the server side 188 to the appropriate NAU(s) on the user side 199. The bi-directional communications, as described herein, between the server side 188 and the user side 199 are indicated by the bi-directional arrow 466.

FIG. 5 depicts an exemplary data exchange 500 between the server side 188 and a NAU(s) on the user side 199 for scenario 2, application 3, in accordance with an embodiment of the present invention. In the embodiment of FIG. 5, enhancement data for VM A 510 is communicated from the server side 188 to the appropriate NAU(s) on the user side 199. Enhancement data for VM B 520 is communicated from the server side 188 to the appropriate NAU(s) on the user side 199. Similarly, enhancement data for VM C 530 is communicated from the server side 188 to the appropriate NAU(s) on the user, side 199. And enhancement data for VM D 540 is communicated from the server side 188 to the appropriate NAU(s) on the user side 199. Finally, the standard version 576 is also communicated from the server side 188 to the appropriate NAU(s) on the user side 199.

In the case of content scenario 3, the same general concept of content scenario 1 is used, but with the difference of having one database per VC. This one database can be described as having a high quality “mother content” from which all VM versions could be derived. The derivation of a VM version is described by metadata that is stored along with the picture content. In various embodiments of the present invention, there is one set of metadata per VM. This metadata describes the signal transform from the “mother version” to the VM version according to the VMS.

The following are the possible server implementation scenarios in the case of content scenario 3 described above. In one embodiment of the present invention, one exemplary server implementation scenario (hereinafter referred to as “scenario 3, application 1”) involves delivering the “mother content” to the NAU, along with all metadata for all VM to the NAU. Then, the NAU extracts the metadata according to the ADS of the user display. The NAU or the display attached to the NAU then performs the signal transformation of the “mother content” to the VM version according to the metadata that accompanies the content (see FIG. 6). In another exemplary server implementation (hereinafter referred to as “scenario 3, application 2”), the NAU communicates the ADS to the content server, which then extracts the metadata determined by the ADS of the user display. This metadata is then delivered with the “mother content” to the NAU. The NAU or the display attached to the NAU then performs the signal transformation of the “mother content” to the VM version according to the metadata that accompanies the content. (see FIG. 7). In yet another exemplary server implementation (hereinafter referred to as “scenario 3, application 3”), the “mother content” is decoded or transcoded to a format, for example, uncompressed, such that the picture signal transformation according to the metadata for one VM can be applied. The VM is then selected according to the ADS, which is communicated by the NAU. Then, before delivering the data, the resultant picture signal is again transcoded or re-compressed for the purpose of transmission to the NAU. The data exchange with the NAU in this case is actually similar to scenario 1 and scenario 2, application 3.

FIG. 6 depicts an exemplary data exchange 600 between the server side 188 and a NAU(s) on the user side 199 for scenario 3, application 1, in accordance with an embodiment of the present invention. In the embodiment of FIG. 6, transformation metadata, VM A 610, is communicated from the server side 188 to the appropriate NAU(s) on the user side 199. The transformation metadata or VM B 620 is also communicated from the server side 188 to the appropriate NAU(s) on the user side 199. Similarly, transformation metadata or VM C 630 is communicated from the server side 188 to the appropriate NAU(s) on the user side 199. And transformation metadata or VM D 640 is communicated from the server side 188 to the appropriate NAU(s) on the user side 199. Finally, “mother data” 676 is communicated from the server side 188 to the appropriate NAU(s) on the user side 199.

FIG. 7 depicts an exemplary data exchange 700 between the server side 188 and a NAU(s) on the user side 199 for scenario 3, application 2, in accordance with an embodiment of the present invention. In the embodiment of FIG. 7, transformation metadata VM 710 is communicated from the server side 188 to the appropriate NAU(s) on the user side 199. In addition, “mother data” 777 is communicated from the server side 188 to the appropriate NAU(s) on the user side 199. In FIG. 7, the bi-directional communications, as described herein, between the server side 188 and the user side 199 are indicated by the bi-directional arrow 766.

Content scenario 2, application 3 has a similar implementation on the user side that is described above with respect to FIG. 2.

Content scenario 2, application 2 has a similar implementation on the user side as that described above with respect to FIG. 2, except for a reformatting/decompression block that combines the two streams (see FIG. 4) transmitted into one displayable picture.

Content scenario 2, application 1 differs from the implementation on the user side as that described above with respect to FIG. 2 in that the NAU 131 receives the whole package of different versions (see FIG. 3). That is, rather than communicating with the content server 111 to pick the VM version, NAU 131 would pick the version on its own.

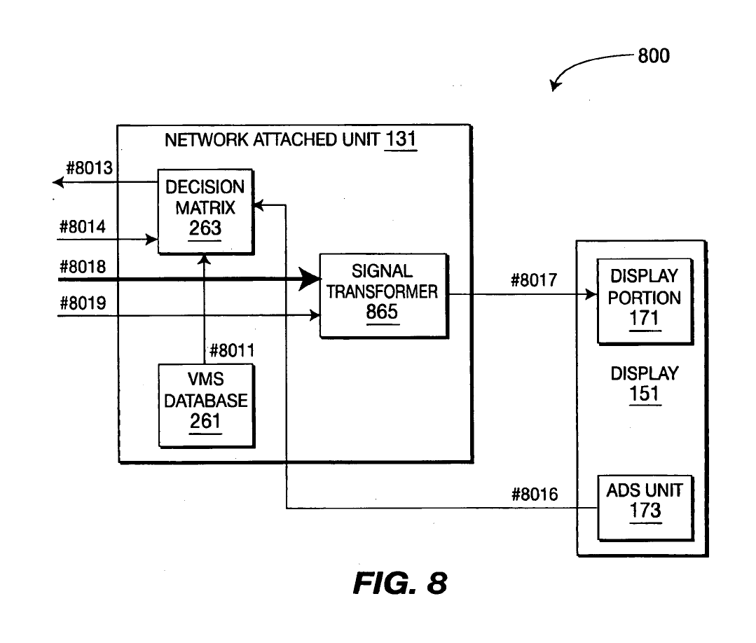

FIG. 8 depicts a high level block diagram of a portion 800 of the user side 199 relating to a single user 141, suitable for use in the system 100 of FIG. 1 in accordance with an embodiment of the present invention. The system 100 of FIG. 1 as depicted in FIG. 8 represents an embodiment relating to content scenario 3, application 2, as defined above. In FIG. 8, the illustrated portion 800 of the user side 199 includes the NAU 131 and the display 151. For illustrative purposes, the description of FIG. 8 is made with respect to user 141 and correspondingly NAU 131 and display 151. However, it is to be appreciated that the inventive concepts of the present invention described with respect to the embodiment of FIG. 8 are equally applicable to the other users and other corresponding NAUs and displays.

Referring to FIG. 8, the display 151 includes a display portion 171 and an ADS unit 173. The NAU 131 includes a VMS database 261, a decision matrix 263, and a signal transformer (also interchangeably referred to herein as “signal transform”) 865.

The VMS database 261 has an output connected to a first input of a decision matrix 263. The decision matrix 263 further includes a second input and an output, both respectively available as an input and an output of the NAU 131, for respectively receiving and transmitting data to the server side 188. An output of the ADS unit 173, which is available as an output of the display 151, is connected to a third input of the decision matrix 263.

The signal transformer 865 includes a first input and a second input, both available as inputs to the NAU 131. The signal transformer 865 includes an output (available as an input of the NAU 131) connected to an input of the display portion 171 (available as an input of the display 151).

The process of selecting the VM version is similar to that described above with respect to the system 100 of FIG. 1. However, one difference is that once the VM version is selected, the decision is communicated to the content server 111. The content server 111 then transmits the “mother data” 8018 and the metadata 8019 needed for transforming the “mother data” into a VM version. The signal transformer 865 applies the signal transform described by the metadata for signal transformation (see FIG. 7).

In an embodiment of the present invention, ADS data can be provided by the display manufacturer. The ADS data can be stored, for example in one embodiment, in a Read Only Memory (ROM) inside the display and read out for the purpose of content negotiation. This readout can occur once during a setup procedure or once per content selection. Of course, the storage of the ADS data is not limited solely to ROMs and any suitable storage or memory device can be utilized in accordance with the present invention. Such storage or memory device can be implemented and/or used in conjunction with the ADS unit 173 depicted in FIG. 2 and FIG. 8.

Moreover, in an embodiment of the present invention, ADS data can also be provided by an external hardware device (s) or external software that analyzes the display properties and stores them in a Read Only Memory or other memory device. Even further, in an alternate embodiment of the present invention, ADS data can be provided by an external local or network based resource. For example, there may be a database that includes ADS data for several models of displays. This database would allow the uploading of ADS data to the NAU 131, depending on the product reference, in order to store them in a storage device.

Having described preferred embodiments for a method and system for providing display device specific content over a network architecture (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method for providing display device specific video content over a network, comprising:
determining a plurality of virtual model versions of the video content generated in accordance with a plurality of respective virtual device models, each of the plurality of virtual device models having a virtual model specification which represents at least one display feature of a particular display; and
selecting a particular one of the plurality of virtual model versions for display based on a comparison of at least one of the display features of the virtual model specification and a display feature of an intended display.

2. The method of claim 1, wherein the comparison is based on a best match as determined from a resultant matching score.

3. The method of claim 1, wherein the plurality of virtual model versions respectively include a base layer version and at least one enhancement layer version with respect to the base layer version, each of the at least one enhancement layer version being hierarchical and describing a difference between an immediately preceding layer version from among the base layer version and the at least one enhancement layer version.

4. The method of claim 3, wherein at least one of the enhancement layer versions is stored in an uncompressed format using at least one difference picture between the base layer version and a respective one of the at least one enhancement layer version.

5. The method of claim 3, wherein at least one enhancement layer version is encoded using scalable video coding.

6. The method of claim 5, wherein the scalable video coding is compliant with the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 recommendation.

7. The method of claim 3, wherein each of the plurality of virtual model versions is derivable from the base layer version and at least one of the at least one enhancement layer version.

8. The method of claim 3, further comprising transmitting each of the plurality of virtual model versions for remote relevant data extraction with respect to the intended display based on the comparison.

9. The method of claim 3, further comprising transmitting only a relevant one of the plurality of virtual model versions responsive to a determination of the display feature of the intended display for use in the comparison.

10. The method of claim 9, further comprising transcoding the relevant one of the plurality of virtual model versions represented by the base layer version and at least one of the at least one enhancement layer version to a single layer stream for transmission froth at least one content server.

11. The method of claim 1, wherein the plurality of virtual model versions respectively include a reference version from which all of the plurality of virtual model versions are derivable and at least one set of metadata, the at least one set of metadata respectively including control data describing at least one signal transformation operation relating to a difference between the reference version and a respective one of the plurality of virtual model versions.

12. The method of claim 11, further comprising transmitting the reference version and each of the sets of metadata for remote relevant data extraction with respect to the intended display based on the comparison.

13. The method of claim 12, further comprising transmitting the reference version and at least one relevant one of the at least one set of metadata responsive to a communication of the display feature of the intended display for use in the comparison.

14. The method of claim 12, further comprising:
applying at least one relevant one of the at least one set of metadata to the reference version to transform the reference version to a final consumption version corresponding to the intended display; and
transmitting the final version for display on the intended display.

15. The method of claim 1, wherein the plurality of virtual model versions are disposed remotely in respective ones of a plurality of databases.

16. The method of claim 1, further comprising receiving each of the plurality of virtual model versions from at least one remote location for local relevant data extraction with respect to the intended display based on the comparison.

17. The method of claim 1, further comprising receiving only a relevant one of the plurality of virtual model versions from at least one remote location responsive to a communication of the display feature of the intended display for use in the comparison.

18. The method of claim 17, further comprising transcoding the relevant one of the plurality of virtual model versions, represented by the base layer version and at least one of the at least one enhancement layer version, to a single layer stream for transmission.

19. The method of claim 1, wherein the plurality of virtual model versions respectively include a reference version from which all of the plurality of virtual model versions are derivable and at least one set of metadata, each of the at least one set of metadata respectively including control data describing at least one signal transformation operation relating to a difference between the reference version and a respective one of the plurality of virtual model versions.

20. The method of claim 19, further comprising receiving the reference version and each of the sets of metadata from at least one remote location for local relevant data extraction with respect to the intended display based on the comparison.

21. The method of claim 19, further comprising receiving the reference version and at least one relevant one of the at least one set of metadata from at least one remote location responsive to a communication of the display feature of the intended display for use in the comparison.

22. The method of claim 19, wherein at least one relevant one of the at least one set of metadata is remotely applied to the reference version at at least one remote location to transform the reference version to a final consumption version corresponding to the intended display.

23. The method of claim 1, further comprising obtaining the at least one display feature of the intended display from at least one of a manufacturer of the intended display, an external device that determines the at least one feature of the intended display, and an external database.

24. A system for providing display device specific video content over a network, comprising:
at least one content server for storing a plurality of virtual model versions of the video content generated in accordance with a plurality of respective virtual device models, each of the plurality of virtual device models having a virtual model specification which represents at least one display feature of a particular display; and
at least one network attached unit for enabling a selection of a particular one of the plurality of virtual model versions for display based on a comparison of at least one of the display features of the virtual model specification and a display feature of an intended display.

25. The system of claim 24, wherein said at least one content server engages in negotiations with said at least one network attached unit to permit a remote selection of a particular one of the plurality of virtual model versions by said at least one network attached unit.

26. The system of claim 24, wherein said at least one network attached unit engages in negotiations with said at least one content server to perform a selection of a particular one of a plurality of virtual model versions of the content.

27. The system of claim 24, wherein said at least one content server comprises a plurality of databases, each of the plurality of databases storing at least one of the plurality of virtual model versions.

28. The system of claim 27, wherein said at least one content server engages in the negotiations to further permit a determination of which of the plurality of virtual device versions is locally available at respective ones of the plurality of databases.

29. The system of claim 1, wherein the comparison is based on a best match as determined from a resultant matching score.

30. The system of claim 1, wherein the plurality of virtual model versions respectively include a base layer version and at least one enhancement layer version with respect to the base layer version, each of the at least one enhancement layer version being hierarchical and describing a difference between an immediately preceding layer version from among the base layer version and the at least one enhancement layer version.

31. The system of claim 30, wherein at least one of the enhancement layer version is stored in an uncompressed domain using at least one difference picture between the base layer version and a respective one of the at least one enhancement layer version.

32. The system of claim 30, wherein the at least one enhancement layer is encoded using scalable video coding.

33. The system of claim 32, wherein the scalable video coding is compliant with the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 recommendation.

34. The system of claim 30, wherein each of the plurality of virtual model versions is derivable from the base layer version and at least one of the at least one enhancement layer version.

35. The system of claim 30, wherein each of the plurality of virtual model versions is transmitted from at least one of the at least one content server for remote relevant data extraction with respect to the intended display based on the comparison.

36. The system of claim 6, wherein only a relevant one of the plurality of virtual model versions is transmitted from at least one of the at least one content server responsive to a communication of the display feature of the intended display for use in the comparison.

37. The system of claim 36, wherein the relevant one of the plurality of virtual model versions, represented by the base layer version and at least one of the at least one enhancement layer version, is transcoded to a single layer stream for transmission from the at least one of the at least one content server.

38. The system of claim 1, wherein the plurality of virtual model versions respectively include a reference version from which all of the plurality of virtual model versions are derivable and at least one set of metadata, the at least one set of metadata respectively including control data describing at least one signal transformation operation relating to a difference between the reference version and a respective one of the plurality of virtual model versions.

39. The system of claim 38, wherein the reference version and the at least one set of metadata is transmitted from at least one of the at least one content server for remote relevant data extraction with respect to the intended display based on the comparison.

40. The system of claim 38, wherein the reference version and each of the sets of metadata is received by said network attached unit from at least one remote location for local relevant data extraction with respect to the intended display based on the comparison.

41. The system of claim 38, wherein the reference version and at least one relevant one of the at least one set of metadata are transmitted from at least one of the at least one content server responsive to a communication of the display feature of the intended display for use in the comparison.

42. The system of claim 38, wherein the reference version and at least one relevant one of the at least one set of metadata is received by said network attached unit from at least one remote location responsive to a communication of the display feature of the intended display for use in the comparison.

43. The system of claim 38, wherein at least one relevant one of the at least one set of metadata is applied to the reference version at at least one of the at least one content server to transform the reference version to a final consumption version corresponding to the intended display.

44. The system of claim 43, wherein the final version is communicated by said at least one content server to an intended network attached unit.

45. An apparatus for providing display device specific video content over a network, comprising:
a decision matrix for selecting a particular one of a plurality of stored virtual model versions of said video content and communicating a request for said selected virtual model version; and
a signal transformer for applying a transform to received video content for transforming received video content to the selected virtual model version for display.

46. The apparatus of claim 45, further comprising a database for storing at least one of virtual model versions, virtual device models and display features.

47. The apparatus of claim 45, wherein said virtual device models, each have a virtual model specification which represents at least one display feature of a particular display and wherein said selection is based on a comparison of at least one of the display features of the virtual model specification and a display feature of an intended display.
